(19) United States
(12) Patent Application Publication
(10) Pub. No.: US 2020/0294468 A1
(43) Pub. Date: Sep. 17, 2020

(54) Electronic Devices With Ambient Light Sensor Systems

(71) Applicant: Apple Inc., Cupertino, CA (US)

(72) Inventors: Po-Chieh Hung, Sunnyvale, CA (US); Prashanth S. Holenarsipur, Fremont, CA (US); Serhan O. Isikman, Sunnyvale, CA (US)

(21) Appl. No.: 16/352,745

(22) Filed: Mar. 13, 2019

(51) Int. Cl. G09G 5/10; H04B 10/516

(52) U.S. Cl. CPC G09G 5/10; G09G 2320/064; G09G 2360/144; H04B 10/516

(57) ABSTRACT

An electronic device may have a display with an array of pixels configured to display images for a user. The electronic device may have an ambient light sensor for gathering ambient light information. Control circuitry in the electronic device may control the array of pixels while gathering measurements with the ambient light sensor. This allows the control circuitry to determine which portion of each ambient light sensor measurement is due to ambient light exposure and which portion of each ambient light sensor measurement is due to stray light from the array of pixels. The control circuitry can then remove the stray light contribution to the ambient light sensor measurements to produce corrected readings of ambient light levels. Display adjustments such as display brightness changes and color changes can be made using ambient light readings.

### BACKGROUND

This relates generally to electronic devices, and, more particularly, to electronic devices with light sensors.

Electronic devices such as laptop computers, cellular telephones, and other equipment are sometimes provided with light sensors. For example, ambient light sensors may be incorporated into a device to provide the device with information on current lighting conditions. Ambient light readings may be used in controlling the device. If, for example bright daylight conditions are detected, an electronic device may increase display brightness to compensate. Color ambient light sensors can detect changes in the color of ambient light so that compensating color cast adjustments can be made to displayed content.

It can be challenging to incorporate ambient light sensors into electronic devices. If care is not taken, an ambient light sensor may consume more space in an electronic device than desired. In some arrangements, there may be challenges associated with operating an ambient light sensor accurately due to potential interference from other components.

### SUMMARY

An electronic device may have a housing that separates an interior region of the device from an exterior region. A display with an array of pixels may be located between the interior and exterior regions. During operation, the array of pixels may display images to a user.

The electronic device may have an ambient light sensor for gathering ambient light information. The ambient light sensor may be overlapped by the array of pixels and may receive ambient light that has passed through the array of pixels.

Control circuitry in the electronic device may control the array of pixels while gathering measurements with the ambient light sensor. For example, the control circuitry may modulate the brightness of image frames being displayed by the array of pixels. In an illustrative arrangement, image frame brightness levels are modulated in a repeating sequence. During the repeating sequence, the image frame brightness levels may, for example, be repeatedly changed between multiple different levels.

By modulating image frame brightness, stray light intensity from the display is modulated. This modulation of the stray light allows the control circuitry to determine which portion of each ambient light sensor measurement with the ambient light sensor is due to ambient light exposure and which portion of each ambient light sensor measurement is due to stray light from the array of pixels. The control circuitry can then remove the stray light contribution to the ambient light sensor measurements to produce corrected readings of ambient light levels.

Display adjustments such as display brightness changes and color changes can be made using ambient light readings. If desired, information from the ambient light sensor such as information on the magnitude of stray light from the array of pixels may be used in taking other actions. For example, the control circuitry can make adjustments to compensate for display degradation that is measured using the ambient light sensor.

### BRIEF DESCRIPTION OF THE DRAWINGS

FIG. 1 is a schematic diagram of an illustrative electronic device having an ambient light sensor in accordance with an embodiment.

FIG. 2 is a perspective view of an electronic device with an ambient light sensor in accordance with an embodiment.

FIG. 3 is a cross-sectional side view of an illustrative electronic device with a display and ambient light sensor in accordance with an embodiment.

FIG. 4 is a graph of an illustrative weighting function for use in removing stray display light signals from ambient light measurements in accordance with an embodiment.

FIG. 5 is a diagram of illustrative display frame brightness modulation sequences that may be used while gathering measurements with an ambient light sensor in accordance with an embodiment.

FIG. 6 is a circuit diagram of illustrative circuitry for use in gathering ambient light sensor measurements in accordance with an embodiment.

FIG. 7 is a flow chart of illustrative operations involved in operating an electronic device with an ambient light sensor in accordance with an embodiment.

### DETAILED DESCRIPTION

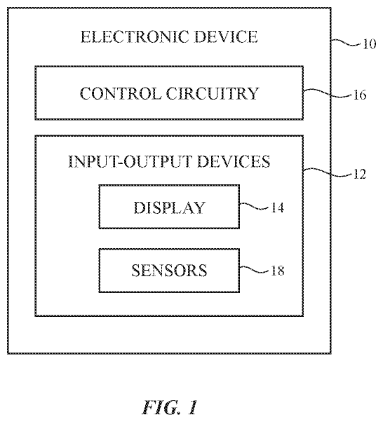

An illustrative electronic device of the type that may be provided with one or more light sensors is shown in FIG. 1. Electronic device 10 may be a computing device such as a laptop computer, a computer monitor containing an embedded computer, a tablet computer, a cellular telephone, a media player, or other handheld or portable electronic device, a smaller device such as a wristwatch or other device worn on a user's wrist, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, equipment that implements the functionality of two or more of these devices, or other electronic equipment.

As shown in FIG. 1, electronic device 10 may have control circuitry 16. Control circuitry 16 may include storage and processing circuitry for supporting the operation of device 10. The storage and processing circuitry may include storage such as hard disk drive storage, nonvolatile memory (e.g., flash memory or other electrically-programmable-read-only memory configured to form a solid state drive), volatile memory (e.g., static or dynamic random-access-memory), etc. Processing circuitry in control circuitry 16 may be used to control the operation of device 10. The processing circuitry may be based on one or more microprocessors, microcontrollers, digital signal processors, baseband processors, power management units, audio chips, application specific integrated circuits, etc. Control circuitry 16 may include communications circuitry for supporting wired and/or wireless communications between device 10 and external equipment. For example, control circuitry 16 may include wireless communications circuitry such as cellular telephone communications circuitry and wireless local area network communications circuitry.

Input-output circuitry in device 10 such as input-output devices 12 may be used to allow data to be supplied to device 10 and to allow data to be provided from device 10 to external devices. Input-output devices 12 may include buttons, joysticks, scrolling wheels, touch pads, key pads, keyboards, microphones, speakers, tone generators, vibrators, cameras, light-emitting diodes and other status indicators, data ports, etc. A user can control the operation of device 10 by supplying commands through input-output devices 12 and may receive status information and other output from device 10 using the output resources of input-output devices 12.

Input-output devices 12 may include one or more displays such as display 14. Display 14 may be a touch screen display that includes a touch sensor for gathering touch input from a user or display 14 may be insensitive to touch. A touch sensor for display 14 may be based on an array of capacitive touch sensor electrodes, acoustic touch sensor structures, resistive touch components, force-based touch sensor structures, a light-based touch sensor, or other suitable touch sensor arrangements.

Input-output devices 12 may also include sensors 18. Sensors 18 may include a capacitive sensor, a light-based proximity sensor, a magnetic sensor, an accelerometer, a force sensor, a touch sensor, a temperature sensor, a pressure sensor, a compass, a microphone, a radio-frequency sensor, a three-dimensional image sensor, a camera, a light-based position sensor (e.g., a lidar sensor), and other sensors. Sensors 18 may also include one or more light detectors that are configured to detect ambient light. Sensors 18 may, for example, include one or more monochrome ambient light sensors and one or more color ambient light sensors that are configured to measure ambient light from the environment in which device 10 is operated. A monochrome ambient light sensor may be used to measure ambient light intensity. A color ambient light sensor may be used to measure the color (color spectrum, color temperature, color coordinates, etc.) of ambient light and may be used to measure ambient light intensity.

To make color measurements, a color ambient light sensor in device 10 may have a light detector such as a photodiode that is overlapped by a tunable wavelength filter and/or may have multiple channels each of which has a light detector such as a photodiode that is overlapped by a filter that passes a different color of light (e.g., a different wavelength band) to that light detector. By processing the readings from each of the multiple channels, the relative intensity of each of the different colors of light can be determined. Using data from the different channels in a color ambient light sensor, control circuitry 16 can therefore produce ambient light color temperature measurements and other color measurements (e.g., colors represented in color coordinates, etc.). The ambient light spectrum information may be used in controlling display 14 and/or in taking other actions in device 10. As an example, the color cast of images displayed on display 14 can be adjusted based on ambient light color measurement (e.g., to make the images on display 14 yellower in warm ambient lighting conditions and to make the images on display 14 bluer in cold ambient lighting conditions). If desired, display brightness may be automatically increased by control circuitry 16 in response to detection of bright ambient light conditions and may be automatically decreased by control circuitry 16 in response to detection of dim ambient light conditions.

Electronic device 10 may include one or more ambient light sensors. Illustrative arrangements in which device 10 includes a single ambient light sensor are sometimes described herein as an example. In some configurations, the ambient light sensor may be located in a portion of device 10 where there is a potential for light interference from light-emitting components in device 10 that emit stray light. For example, the ambient light sensor may be overlapped by a pixel array in display 14 (e.g., an active area of the display that is configured to display images) that has a potential to generate stray light. The pixel array may have transparent portions (e.g., transparent gaps between metal traces and other opaque structures) or may have a window opening so that ambient light may pass through the pixel array to the overlapped ambient light sensor. By locating the ambient light sensor behind the active area of the display, the appearance of device 10 may be enhanced and the amount of space consumed by the ambient light sensor may be reduced. Configurations in which the ambient light sensor is located under an inactive display area (e.g., a notch or pixel array window opening that is free of pixels) or is located elsewhere within device 10 may also be used.

During operation, control circuitry 16 can gather measurements with the ambient light sensor while controlling display 14 or other light source that generates stray light. Control circuitry 16 can then process the data gathered from the ambient light sensor to produce accurate ambient light measurements even in scenarios in which sensor data has been gathered in the presence of stray display light or other stray light that has the potential to interfere with ambient light sensor readings.

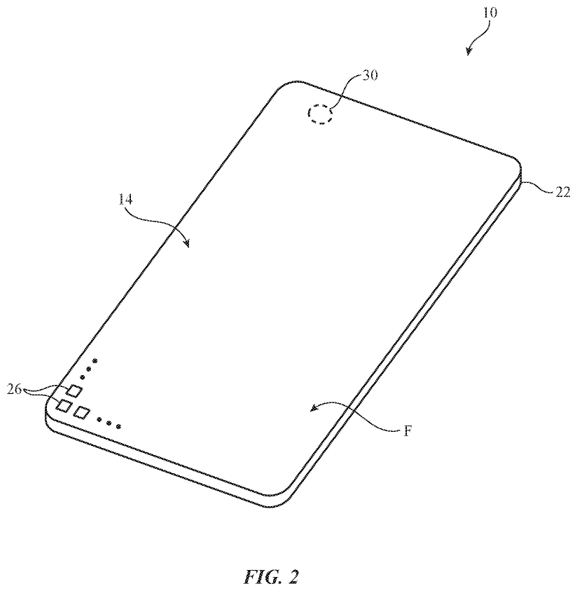

A perspective view of an illustrative electronic device of the type that may include an ambient light sensor is shown in FIG. 2. In the example of FIG. 2, device 10 includes a display such as display 14 mounted in housing 22. Display 14 may be a liquid crystal display, an electrophoretic display, an organic light-emitting diode display or other display with an array of light-emitting diodes (e.g., a display that includes pixels having diodes formed from crystalline semiconductor dies), may be a plasma display, may be an electrowetting display, may be a display based on microelectromechanical systems (MEMs) pixels, or may be any other suitable display. Display 14 may have an array of pixels 26 that extend across some or all of front face F of device 10 and/or other external device surfaces. The pixel array may be rectangular or may have other suitable shapes. Display 14 may be protected using a display cover layer (e.g., a transparent front housing layer) such as a layer of transparent glass, clear plastic, sapphire, or other clear layer. The display cover layer may overlap the array of pixels 26.

Housing 22, which may sometimes be referred to as an enclosure or case, may be formed of plastic, glass, ceramics, fiber composites, metal (e.g., stainless steel, aluminum, etc.), other suitable materials, or a combination of any two or more of these materials. Housing 22 and display 14 may separate an interior region of device 10 from an exterior region surrounding device 10. Housing 22 may be formed using a unibody configuration in which some or all of housing 22 is machined or molded as a single structure or may be formed using multiple structures (e.g., an internal frame structure, one or more structures that form exterior housing surfaces, etc.). If desired, a wristband or other strap may be coupled to a main portion of housing 22 (e.g., in configurations in which device 10 is a wristwatch).

Pixels 26 may cover substantially all of the front face of device 10 or display 14 may have inactive areas (e.g., notches, rectangular areas, or other regions) that are free of pixels 26. The inactive areas may be used to accommodate an opening for a speaker and windows for optical components such as image sensors, an ambient light sensor, an optical proximity sensor, a three-dimensional image sensor such as a structured light three-dimensional image sensor, a camera flash, etc. In an illustrative configuration, pixels 26 may extend over front surface F of device 10 and may overlap an ambient light sensor in region 30. In this type of arrangement, ambient light may pass to the ambient light sensor in region 30 through the array of pixels 26 in display 14.

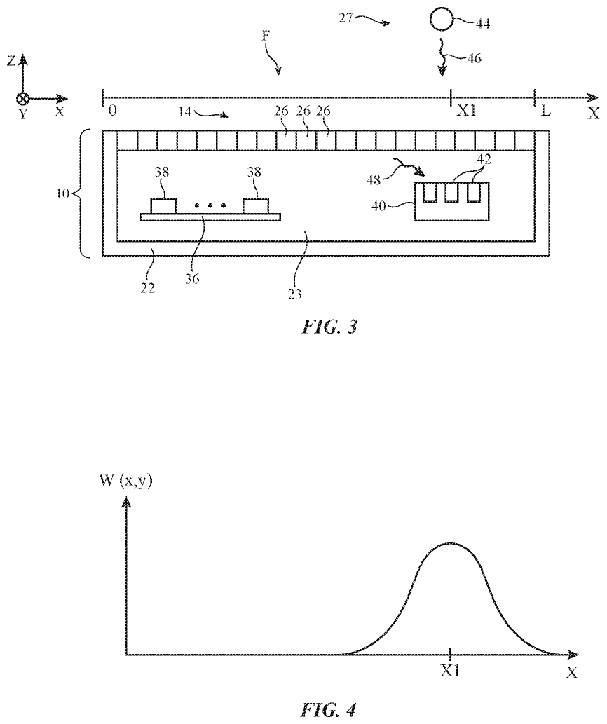

FIG. 3 is a cross-sectional side view of device 10 of FIG. 2 in an illustrative configuration in which pixels 26 overlap ambient light sensor 40. As shown in FIG. 3, ambient light sensor 40 may have one or more photodetectors 42. A single photodetector 42 (or set of photodetectors 42) may be used to make monochromatic light measurements (e.g., measurements of light intensity) or a set of photodetectors 42 that have color filters of different respective colors may be used to make intensity and color measurements on ambient light 46. A multi-channel ambient light sensor may, for example, have at least 2, at least 5, at least 10, fewer than 20, or other suitable number of photodetectors 42, each of which measures light in a different band of colors. By using multiple channels of different colors in this way, ambient light sensor 40 may be used to measure the color of ambient light 46 (e.g., as color coordinates, a color temperature, etc.) as well as the overall intensity of the ambient light 46. Ambient light sensor 40 may be mounted in interior region 23 of housing 22 under display 14. Display 14 and housing 22 may separate interior region 23 from exterior region 27 surrounding device 10. Electrical components 38 (see, e.g., control circuitry 16 and input-output devices 12 of FIG. 1) may be mounted within interior region 23 (e.g., on one or more printed circuits such as printed circuit 36).

Display 14 has an array of pixels 26. Pixels 26 extend over front face F of device 10 and form an active area for display 14 in which images are displayed. A display cover layer (e.g., a layer of glass, crystalline material such as sapphire, polymer, etc.) may overlap pixels 26. Each pixel 26 may be formed from thin-film transistors and other components (e.g., liquid crystal display pixel components such as pixel electrodes, light-emitting diode pixel components such as light-emitting diodes, etc.). Metal traces and other opaque structures in pixels 26 may block light, however, the array of pixels 26 may also include transparent regions between the opaque structures. The presence of transparent areas in display 14 allows ambient light 46 from external light sources such as external light source 44 in exterior region 27 to pass through the array of pixels 26 to reach ambient light sensor 40 in interior region 23. Window openings, notches, and other structures may also be formed in display 14 to allow ambient light to pass to ambient light sensor 40.

As the example of FIG. 3 demonstrates, ambient light sensor 40 may, in some configurations, be mounted under display 14. In this location within interior 23 of housing 22, the active area of display 14 that is formed by pixels 26 overlaps ambient light sensor 40 when viewed from the exterior of device 10 (e.g., when viewing front face F). By mounting ambient light sensor 40 behind pixels 26 in this way, the overall size of device 10 can be reduced, the appearance of device 10 may be enhanced, and inactive display area may be reduced. If desired, ambient light sensor 40 may be located adjacent to display 14 without receiving ambient light through display 14 (e.g., ambient light sensor 40 may be near to display 14 but not overlapped by pixels 26). Arrangements in which ambient light sensor 40 receives ambient light through an overlapping display may sometimes be described as an example.

During operation of display 14 to display an image for a user, pixels 26 of display 14 emit light such as stray display light 48. Some of light 48 from display 14 may pass through interior region 23 to ambient light sensor 40 or may otherwise reach ambient light sensor 40. This stray light therefore represents a source of noise that has the potential to interfere with accurate measurements of ambient light 46 by ambient light sensor 40. Stray light also represents a source of noise in configurations in which display 14 and ambient light sensor are located near to each other but do not overlap.

Control circuitry 16 may gather measurements with ambient light sensor 40 while controlling display 14. In this way, control circuitry 16 can help discriminate between contributions to ambient light sensor measurements from sensor 40 that are due to ambient light 46 and contributions to the ambient light sensor measurements from sensor 40 that are due to display light 48.

With one illustrative configuration, control circuitry 16 uses knowledge of the location of pixels 26 relative to ambient light sensor 40 and knowledge of the images being displayed on display 14 to enhance ambient light sensor accuracy. During the process of displaying an image on display 14, control circuitry 16 obtains image frames F (frames of image data) to display on the array of pixels 26 in display 14. For each image frame F, control circuitry 16 therefore knows the digital count value (e.g., a value of 0-255) for each pixel 26 in display 14.

During manufacturing or at any other appropriate time, device 10 can be characterized to identify a weighting function W(x,y) that represents the fraction of emitted light from each pixel 26 that is detected by ambient light sensor 40 for each location (x,y) across the surface of display 14. As shown in the graph of FIG. 4, weighting function W(x,y) may have a low value (e.g., zero) for locations that are far from the location of ambient light sensor 40 (e.g., locations that are far from position x1 along the x dimension in the example of FIGS. 3 and 4). At locations in display 14 where pixels 26 directly overlap ambient light sensor 40 or are close to sensor 40, the value of weighting function W(x,y) is higher, indicating that more light 48 from pixels 26 of display 14 will reach ambient light sensor 40 when those pixels are close to ambient light sensor 40.

The weighting function W and the pixel values of pixels 26 for each frame F of data can be used to determine the amount of light 48 that is being received by ambient light sensor 40 for each frame F. During operation, the pixel intensity for each pixel 26 in a frame of data being displayed on display 14 is obtained by control circuitry 16 (e.g., by examining the contents of a display frame buffer that contains the frame of data, etc.). Image data may be represented digitally (e.g., as a digital count value DC for each pixel that ranges from 0 to 255 or other suitable range of digital values). For each pixel, the intensity PI of the light emitted by the pixel can be determined from equation 1.

PI=c*(DC/DCₘₐₓ)^{γ} (1)

In equation 1, DC is the image data (digital pixel value) for the pixel, DCₘₐₓ is the maximum value of DC (e.g., 255 for an 8-bit system), and c and γ are constants determined by characterizing the behavior of the display (e.g., during manufacturing). (If desired, different colors of pixels may be characterized using different corresponding values of c and γ). In determining how much stray light 48 from frame F is being measured by ambient light sensor 40, the values of pixel intensity PI for each of the pixels in frame F can be multiplied by the corresponding weighting function value appropriate for the location of that pixel (e.g., the value of PI for each location (x,y) may be multiplied by the corresponding weighting function value W(x,y) for that location). The results of this multiplication are integrated over all x and y values. The total integrated value from this process represents the intensity of light 48 from display 14 that is expected to be measured by ambient light sensor 40 for that frame F of image data. This determination can be used to determine the amount of the output of ambient light sensor 40 that is due to display crosstalk (stray display light 48) and thereby the amount of the measurement made by ambient light sensor 40 that actually represents ambient light 46. For example, if the total amount of stray light 48 that is received by sensor 40 is N and the value of the measurement made by ambient light sensor 40 while frame F is being displayed is M, the intensity AL of ambient light 46 that is present may be determined using equation 2.

AL=M−N (2)

As shown in FIG. 3, the actual amount of ambient light 46 that is present in the vicinity of device 10 and is being measured by sensor 40 is equal to the output of sensor 40 (e.g., the total amount of light measured by sensor 40, represented by value M) minus the amount of stray light 48 (represented by value N) that is present as determined using weighting function W and the known image data values. Because weighting function W is used to represent the amount of crosstalk expected from pixels 26 for each pixel location (x,y) in display 14, weighting function W may sometimes be referred to as a crosstalk weighting function, spatially dependent crosstalk weighting function, or stray light weighting function.

As an alternative or in addition to using weighting function W and knowledge of the image data in each frame F to estimate the intensity of stray light 48 so that this stray light contribution can be removed from the ambient light sensor output to accurately measure ambient light 46, control circuitry 16 can actively modulate the brightness of display 14 while making synchronized measurements with ambient light sensor 40. Control circuitry 16 can use the modulation of display brightness to help determine which portion of the ambient light sensor output is associated with stray display light (which changes with the modulation) and which portion of ambient light sensor measurements is associated with ambient light 46 (which is relatively constant during modulation).

The brightness of light 48 can be modulated using any suitable modulation scheme. With one illustrative arrangement, the brightness of the light output from display 14 may be adjusted by adjusting frame brightness on a frame-by-frame basis while making synchronized ambient light sensor measurements with ambient light sensor 40.

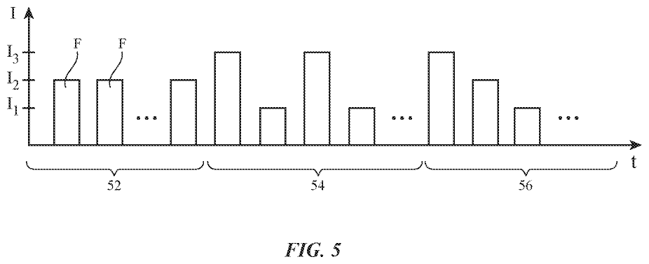

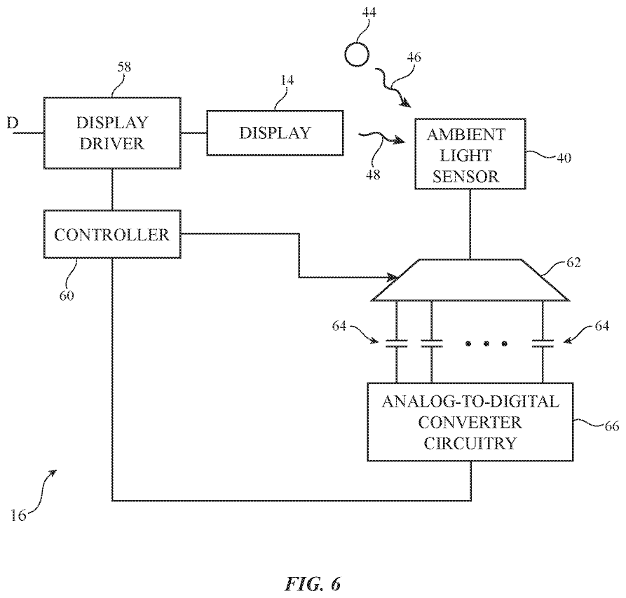

The graph of FIG. 5 illustrates how the total light intensity I (e.g., the brightness level) that is associated with a series of image data frames F may be modulated. During illustrative time period 52, frames F have normal intensity 12 (e.g., a normal brightness level that is effectively constant because this level is fixed or only changes slowly—e.g., in response to a user brightness adjustment or an automatic adjustment of the overall normal brightness of display 14 due to measured changes in ambient light level). When it is desired to make ambient light sensor measurements, control circuitry 16 may rapidly modulate the brightness levels of image frames F. For example, control circuitry may vary the output of display 14 as shown in illustrative time period 54, so that the intensity I of frames F varies between higher intensity I3 and lower intensity I1 while ambient light sensor 40 synchronously gathers ambient light measurements corresponding to each frame. The depth of modulation (e.g., [I3−I1]/I3) may have any suitable value (e.g., modulation depth may be at least 1%, at least 10%, at least 50%, 100%, less than 100%, less than 75%, less than 40%, less than 20%, or other suitable value). Frame-by-frame brightness adjustment variations take place quickly, so a user's eye will not generally notice any visible flickering on display 14.

As shown in FIG. 5, intensity (image frame brightness level) I3 may be greater than I2 and intensity I1 may be less than I1. If desired the values of I3 and I1 may be selected so that the average light output intensity of frames F during time period 54 is equal to the average light output intensity of the normal frames F that are present during time period 52. This helps avoid undesired visible changes in the observed brightness of display 14 when viewed by a user (because a user's eye is not generally sensitive to very rapid changes in intensity such as those experienced between a pair of successive frames). In some arrangements (see, e.g., illustrative time period 56), control circuitry 16 may modulate the brightness levels of image frames F so that there are three or more different light intensities used for frames F.

During modulation of a set of multiple frames so that these frames have different brightness levels, control circuitry 16 synchronously gathers ambient light sensor readings from sensor 40 (e.g., a measurement may be made with sensor 40 corresponding to each image frame F at its modulated brightness level). Frames F may, as an example, be varied in intensity so that frames F repeatedly exhibit intensities I3, I2, and I1, as shown in time period 56 (e.g., so that the average light output of frames F in period 56 is unchanged from the normal light output in period 52). The total number of image frames that are modulated in connection with producing a given ambient light measurement may have any suitable value (at least 2, at least 3, at least 10, at least 50, at least 100, fewer than 150, fewer than 70, fewer than 30, fewer than 15, etc.). With this arrangement, control circuitry 16 may be configured to determine an ambient light level by modulating the brightness levels of each of a plurality of the image frames in a set of image frames while synchronously gathering a plurality of respective measurements with the ambient light sensor. Control circuitry 16 may perform the measurement process (modulating a set of frames in a sequence with a desired repeating pattern of different brightness levels such as high/low, high/low, etc. or high/medium/low, high, medium, low, etc. for a desired measurement duration) continuously or periodically (e.g., separated by constant or varying non-measurement intervals).

In configurations where characterization information for display 14 is known to control circuitry 16 (e.g., where the values of c and γ of equation 1 are known from manufacturing characterization operations), control circuitry 16 may use the approach of time period 54. In configurations where values such as c and γ of equation 1 are not known, it may be desirable to gather ambient light measurements for a larger number of different frame intensities (e.g., using a repeating pattern of three or more different frame intensities as illustrated in the approach of time period 54). If desired, ambient light sensor measurements may be gathered over multiple frames F for a duration of is to 1 m, at least 0.1 s, at least 0.5 s, at least 2 s, less than 100 s, less than 10 s, less than 3 s, less than 1.5 s, or other suitable duration to enhance the signal-to-noise ratio of these measurements. Measurements may be made continuously or may be made at intervals TI. The value of periodic measurement interval TI may be at least 1 s, at least 10 s, at least 100 s, less than 200 s, less than 50 s, less than 15 s, less than 5 s, less than 2 s, or other suitable value.

Any suitable modulation depth may be used when modulating the brightness of frames F. As a first example (sometimes referred to as weak flicker case), the non-zero value of 13 is equal to twice the non-zero value of IL In this scenario, ambient light intensity AL may be determined using equation 3.

AL=M(frames of intensity I1)*2−M(frames of intensity I3) (3)

As a second example (sometimes referred to as a strong flicker case), even frames may have a first non-zero intensity INZ and odd frames may have zero intensity IZ=0. In this scenario, ambient light intensity AL may be determined using equation 4 (e.g., AL may be measured by gathering output from sensor 40 only during frames where pixels 46 are not emitting light).

AL=M(frames of intensity IZ) (4)

If desired, the signal-to-noise ratios of ambient light measurements may be enhanced by averaging measurements made over multiple frames F. This may be performed digitally using control circuitry 16 and/or control circuitry 16 may have capacitors or other analog components for accumulating ambient light sensor measurements taken over multiple frames.

An illustrative analog measurement accumulation circuit, which may be implemented as part of control circuitry 16 of FIG. 1, is shown in FIG. 6. As shown in FIG. 6, circuitry 16 may include a controller such as controller 60. Digital image data D may be received by display driver 58. Controller 60 may control display driver 58 to adjust the brightness of the image on display 14 and/or may otherwise modulate display intensity. This modulates the intensity of stray display light 48.

Ambient light sensor 40 may be used to make measurements in synchronization with frames F of displayed image data on display 14. The measurements that are made each include a light contribution from ambient light 46 and a light contribution from stray light 48. Intensity measurements may be made in a pattern. For example, in a modulation sequence with a repeating two-intensity pattern, odd frames FO may be altered with even frames FE. A set of capacitors 64 may receive and accumulate output signals from ambient light sensor 40. For example, in a scenario in which sensor 40 makes alternating odd-frame measurements and even-frame measurements, there may be an odd-frame capacitor 64 and an even-frame capacitor 64. Controller 60 may direct multiplexer 62 to alternately short sensor 40 to the odd-frame and even-frame capacitors. For example, during each odd frame, multiplexer 62 may short the odd-frame capacitor to the output of sensor 40 and during each even frame, multiplexer 62 may short the even-frame capacitor to the output of sensor 40. In this way, odd-frame measurements from sensor 40 can be accumulated in the odd-frame capacitor and even-frame measurements from sensor 40 can be accumulated in the even-frame capacitor. In arrangements where three or more different frame intensities are used, additional capacitors 64 can be selectively switched into use.

After ambient light measurements are finished, analog-to-digital converter circuitry 66 can digitize the voltage on each capacitor 64 and can provide corresponding aggregated (averaged) odd-frame and even-frame ambient light sensor measurements to controller 60 for processing. If desired, digital accumulation (averaging) schemes may be used (e.g., by separately digitally accumulating data for odd frames and for even frames, etc.). The use of analog circuit components such as capacitors 64 to accumulate multiple ambient light sensor measurements over successive frames is illustrative.

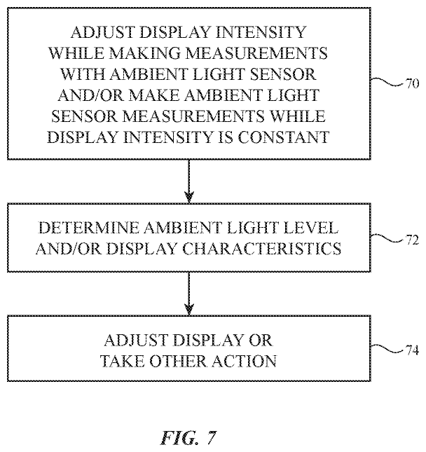

FIG. 7 is a flow chart of illustrative operations involved in gathering and using ambient light measurements in device 10.

During the operations of block 70, control circuitry 16 may modulate a stray light source such as display 14 while gathering measurements from ambient light sensor 40 and/or may gather measurements from ambient light sensor 40 while stray light intensity is constant (e.g., while display brightness is constant). For example, control circuitry 16 may vary image frame brightness between two or more different brightness levels in a repeating pattern while synchronously making measurements with sensor 40 (e.g., by gathering an ambient light sensor measurement corresponding to each frame) and/or control circuitry 16 may use weighting function W to determine how much stray display light 48 from each frame is contributing to the ambient light sensor measurement associated with that frame.

If desired, control circuitry 16 may use a frame-intensity-modulation approach to produce a first estimate of ambient light level and may use a weighting-function approach to produce a second estimate of ambient light level. The first and second estimates may then be combined (e.g., by averaging these two values, by selecting one or the other value based on predetermined selection criteria, by weighting the first and second estimates by different amounts, etc.). Using a hybrid approach of this type may help enhance ambient light measurement accuracy.

The human eye may be more sensitive to display flicker at high ambient light intensities than at low ambient light conditions. If desired, control circuitry 16 can therefore use a weighting-function approach at ambient light intensities above a first threshold (e.g., during bright ambient lighting conditions, where flicker from modulating display intensity might be more noticeable to a user) and can use a display-frame-brightness-modulation approach at ambient light intensities below the first threshold or below a lower second threshold (e.g., during dim ambient lighting conditions, where flicker from modulating display intensity may be unnoticeable to the user).

Alternatively, control circuitry 16 can use a first display-frame-brightness-modulation approach where the difference in frame brightness levels between frames is relatively small (e.g., by using a relatively small first modulation depth) in bright ambient lighting conditions, and can use a second display-frame-brightness-modulation approach where the difference in frame intensities between frames is relatively large (e.g., by using a relatively larger second modulation depth that is larger than the first modulation depth) in dim ambient lighting conditions.

Measurements with sensor 40 can take place over multiple frames to help accumulate multiple samples that are subsequently used together (e.g., by summation, averaging, etc.) to help reduce measurement noise. If desired, measurement periods (for a single frame or a set of multiple frames) can be separated by non-measurement intervals (e.g., one or more measurements can be taken over a time period of 1 s or other suitable measurement duration and this process can be repeated once per minute or other suitable measurement repeating interval). The interval between each measurement and/or the interval between each set of measurements can be varied as a function of time, thereby reducing the potential for undesired interference (beat frequencies) due to an interplay between the timing of the measurements made with ambient light sensor 40 and the fluctuating light output intensity of ambient light sources with periodic output (e.g., to reduce interference due to flicker in fluorescent lights or other ambient light flicker).

During the operations of block 72, control circuitry 16 can process the measurements taken at block 70 to produce ambient light values (e.g., measurement of ambient light 46 from which noise contributions from stray display light 48 have been removed). If desired, the measurements gathered with ambient light sensor 40 may be used to monitor the magnitude of display light 48 over time (e.g., the amount of light 48 produced for a given image data value). In this way, degradation of pixels 26 (e.g., aging-based degradation of display 14) may be tracked. Control circuitry 16 can then compensate for measured display degradation (e.g., by increasing the intensities of image data values or by adjusting display driver circuitry 58 or other circuitry to enhance the brightness of display 14 by an amount that accounts for the loss in a measured degradation in display output intensity). The gamma (γ) of display 14 can also be measured by adjusting the light output of pixels 26 while making measurements of light 48 with ambient light sensor 40.

During the operations of block 74, control circuitry 16 can take action based on the measurements of blocks 70 and 72. For example, if bright ambient lighting conditions are detected, control circuitry 16 can increase the brightness of display 14 (e.g., the intensity of normal image frames may be increased) and if dim ambient lighting conditions are detected, control circuitry 16 can decrease the brightness of display 14 (e.g., the intensity of normal image frames may be decreased). As another example, if display degradation is detected, control circuitry 16 can compensate for the loss of display output capability to ensure that the images viewed by a user have sufficient brightness. If desired, color changes in display 14 can be detected and control circuitry 16 can make color cast adjustments to compensate. Display gamma measurements can be used to characterize the operation of display 14 as a function of digital image data value. This characterization of display 14, which may sometimes be referred to as self-evaluated gamma information or self-evaluated display characteristics, may be maintained in control circuitry 16 (e.g., to use in subsequent ambient light measurements where knowledge of the behavior of display 14 may help control circuitry 16 to accurately remove stray display light contributions to ambient light sensor measurements).

Although sometimes described herein in the context of removing stray light noise due to stray display light, control circuitry 16 may, if desired, remove stray light contributions due to light from other stray light sources (e.g., light-emitting diodes or other light-emitting devices in status indicator lights, light-emitting components used for providing external illumination, and/or other light sources).

Device 10 may be operated in a system that uses personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Table of Reference Numerals

| | | | |
|---|---|---|---|
| 10 | Electronic Device | 12 | Input-Output Devices |
| 14 | Display | 16 | Control Circuitry |
| 18 | Sensors | 23 | Interior Region |
| 22 | Housing | 26 | Pixels |
| 40 | Ambient Light | 44 | Light Source |
| | Sensor | | |
| 48 | Display Light | 46 | Ambient Light |
| 36 | Printed Circuit | 42 | Photodetectors |
| 38 | Electrical | 52, 54, 56 | Time Periods |
| | Components | | |
| 58 | Display Driver | 60 | Controller |
| 62 | Multiplexer | 64 | Capacitors |
| 66 | Analog-to-Digital | 27 | Exterior Region |
| | Converter Circuitry | | |

The foregoing is merely illustrative and various modifications can be made to the described embodiments. The foregoing embodiments may be implemented individually or in any combination.

What is claimed is:

1. An electronic device, comprising:
a housing between an exterior region and an interior region;
a light-emitting device;
an ambient light sensor in the interior region that is configured to gather ambient light sensor measurements that include a first contribution from ambient light from the exterior region and that include a second contribution from light from the light-emitting device; and
control circuitry configured to:
modulate the light-emitting device while gathering the ambient light sensor measurements to determine the second contribution; and
remove the second contribution from the ambient light sensor measurements to produce ambient light intensity measurements.

2. The electronic device defined in claim 1 wherein the display is configured to display frames of image data and wherein the control circuitry is configured to modulate the display by modulating brightness levels for the frames while synchronously gathering the ambient light sensor measurements with the ambient light sensor.

3. The electronic device defined in claim 2 wherein the light-emitting device comprises a display and wherein the ambient light sensor is configured to measure the first contribution on ambient light that has passed through the display.

4. The electronic device defined in claim 2 wherein the control circuitry is configured to display the frames with a first brightness level while no ambient light sensor measurements are being made and with alternating second and third brightness levels that are respectively greater and less than the first brightness level while gathering the ambient light sensor measurements with the ambient light sensor.

5. The electronic device defined in claim 4 wherein the second and third brightness levels averaged together equal the first brightness level.

6. The electronic device defined in claim 4 wherein the control circuitry is configured to select the second and third brightness levels based on ambient light level.

7. The electronic device defined in claim 6 wherein the control circuitry is configured to place the second and third brightness levels farther apart at a first ambient light level than at a second ambient light level that is lower than the first ambient light level.

8. The electronic device defined in claim 2 wherein the control circuitry is configured to display the frames with a first brightness level while no ambient light sensor measurements are being made and is configured to display the frames with second, third, and fourth brightness levels that differ from each other while gathering the ambient light sensor measurements with the ambient light sensor.

9. The electronic device defined in claim 2 wherein the control circuitry is configured to accumulate the ambient light sensor measurements over a plurality of the frames.

10. The electronic device defined in claim 2 wherein the control circuitry is configured to vary an interval between ambient light sensor measurements to reduce interference from ambient light flicker.

11. The electronic device defined in claim 2 wherein the control circuitry is configured to use the ambient light sensor to monitor degradation of the display over time based on information on the second contribution.

12. The electronic device defined in claim 2 wherein the control circuitry is configured to use the ambient light sensor to self-evaluate display gamma for the display.

13. An electronic device, comprising:
a housing;
an ambient light sensor;
a display coupled to the housing, wherein the display is configured to display image frames, each image frame having an associated brightness level; and
control circuitry configured to determine an ambient light level by modulating the brightness levels of each of a plurality of the image frames in a set of image frames while synchronously gathering a plurality of respective measurements with the ambient light sensor.

14. The electronic device defined in claim 13 wherein the control circuitry is configured to determine the ambient light level by processing the measurements to remove contributions to the measurements that are associated with light from the display.

15. The electronic device defined in claim 14 wherein the control circuitry is configured to modulate the brightness levels by alternating the brightness levels of successive frames between first and second different brightness levels.

16. The electronic device defined in claim 14 wherein the control circuitry is configured to modulate the brightness levels by adjusting the brightness levels of the frames repeatedly between first, second, and third different brightness levels.

17. The electronic device defined in claim 14 wherein the control circuitry is configured to modulate the image frames differently at a first ambient light level than at a different second ambient light level.

18. An electronic device, comprising:
an array of pixels configured to display image frames;
an ambient light sensor; and
control circuitry configured to adjust the image frames in a repeating sequence to modulate emitted light intensity from the array of pixels while synchronously gathering measurements with the ambient light sensor.

19. The electronic device defined in claim 18 wherein the control circuitry is configured to produce an ambient light measurement by removing stray light contributions due to light from the array of pixels from the measurements gathered with the ambient light sensor and wherein the ambient light sensor is configured to gather the measurements while ambient light is passing to the ambient light sensor through the array of pixels.

20. The electronic device defined in claim 18 wherein the control circuitry is configured to adjust the image frames in a repeating sequence that has at least two different image frame brightness levels.
